(19) United States
(12) Patent Application Publication
(10) Pub. No.: US 2026/0178729 A1
(43) Pub. Date: Jun. 25, 2026

(54) METHODS AND SYSTEMS FOR MALICIOUS ACTIVITY DETECTION AND PREVENTION

(71) Applicant: SK Hynix NAND Product Solutions Corp. (dba Solidigm), Rancho Cordova, CA (US)

(72) Inventors: Andre SILVEIRA, Gold River, CA (US); Gamil A. CAIN, El Dorado Hills, CA (US); Ryan HUARD, Vancouver (CA); Wilson YOUNG, Burnaby (CA)

(21) Appl. No.: 18/987,801

(22) Filed: Dec. 19, 2024

(51) Int. Cl. G06F 21/55; G06F 21/56

(52) U.S. Cl. CPC G06F 21/554; G06F 21/566; G06F 21/568

(57) ABSTRACT

An example method of preventing malicious activity is performed at a memory device that comprises non-volatile memory and control circuitry. The method includes receiving a set of one or more data requests from a host and determining whether the set of one or more data requests is anomalous. In accordance with a determination that the set of one or more data request is anomalous, the method includes initiating a remedial action. In accordance with a determination that the set of one or more data requests is not anomalous, the method includes performing a set of one or more operations corresponding to the set of one or more data requests in the non-volatile memory.

### TECHNICAL FIELD

This application relates generally to data storage devices, including but not limited to methods, systems, and devices for preventing malicious activities within data storage devices.

### BACKGROUND

Current approaches for detecting malware (e.g., ransomware) and malicious activity operate in a host environment. For example, an operating system (OS) or application scans for specific changes to a system (e.g., modification of system files) that correspond to known malicious activity. However, sophisticated malware can cover its tracks, e.g., by eliminating logs, modifying the OS, disabling malware detection, and the like. Because current approaches execute in the same environment as the malware, they are more susceptible to the attacks.

### SUMMARY

The present disclosure describes, amongst other things, techniques for detecting and responding to malicious activity at a memory level (e.g., within a memory device). Detecting and responding to malicious activity at the memory level makes the security less susceptible to OS-based malware and rootkit-based malware. For example, an SSD can detect malware (or other malicious activity) intended to operate on the data stored within the SSD and enable protections to defend against it.

In one aspect, a method of preventing malicious activity is performed at a data storage device (also sometimes referred to as a memory device) that comprises memory (e.g., non-volatile memory and/or volatile memory) and control circuitry. The method includes: (i) receiving a set of one or more data requests from a host; (ii) determining whether the set of one or more data requests is anomalous; (iii) in accordance with a determination that the set of one or more data request is anomalous, initiating a remedial action; and (iv) in accordance with a determination that the set of one or more data requests is not anomalous, performing a set of one or more operations corresponding to the set of one or more data requests in the non-volatile memory. For example, the data request(s) may be determined to be anomalous based on (1) an entropy of the data request(s), (2) the data requests corresponding to known malicious behaviour, and/or (3) the data requests not corresponding to standard workload behaviour. Example remedial actions include (a) notifying an administrator, (b) blocking a namespace, address range, or user access, (c) switching to a read-only mode, and/or (d) switching to a honey-pot mode.

In accordance with some embodiments, a memory device is provided. The memory device includes control circuitry and memory storing one or more sets of instructions. The one or more sets of instructions include instructions for performing any of the methods described herein.

In accordance with some embodiments, a non-transitory computer-readable storage medium is provided. The non-transitory computer-readable storage medium stores one or more sets of instructions for execution by a memory device (or other type of computing system). The one or more sets of instructions include instructions for performing any of the methods described herein.

Thus, devices and systems are disclosed with methods for identifying and preventing malicious activity. Such methods, devices, and systems may complement or replace conventional methods, devices, and systems for identifying and preventing malicious activity.

The features and advantages described in the specification are not necessarily all inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example system module in an example electronic device in accordance with some embodiments.

FIG. 2 is a block diagram illustrating a storage system of an example electronic device having one or more memory access queues in accordance with some embodiments.

FIG. 3 is a block diagram of an example computing system that includes a storage system having an internal processing capability in accordance with some embodiments.

FIG. 4 is a block diagram illustrating an example computing system including a storage system that operates in compliance with a storage access and transport protocol in accordance with some embodiments.

FIG. 5 is a block diagram illustrating an example computing system that includes a host and a storage device in accordance with some embodiments.

FIG. 6 is a flow diagram illustrating an example process for preventing malicious activity in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes means of identifying and preventing malicious activity within a memory device. For example, the memory device may identify unauthorized data modification activity, such as encryption (e.g., ransomware) activity, copying activity, and/or deletion activity. Implementing the malicious activity detection within the memory device makes the detection less susceptible to being circumvented by malware executing on the host device, e.g., in an OS or rootkit environment. As described in greater detail below, the memory device may analyze entropy associated with data requests from the host to identify anomalous behavior. Additionally, or alternatively, the memory device may compare the data requests from the host to known malicious activity and/or known workload activity to identify anomalous behavior. In response to detecting anomalous behavior, the memory device may perform one or more remedial actions, such as generating a notification, blocking a particular namespace, user, and/or address range, switching to a read-only mode, and/or switching to a honey-pot mode. In this way, the memory device can prevent malicious activity involving data stored at the memory device, and alert administrators and/or other security personnel to potential compromise of the host device.

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

### Example Computing Systems and Storage Devices

Memory is used in a computing system to store instructions and data. The data can be processed by one or more processors of the computing system according to the instructions stored in the memory. Multiple memory units may be used in different portions of the computing system to serve different functions. Specifically, the computing system may include non-volatile memory that acts as secondary memory to keep data stored thereon if the computing system is decoupled from a power source or powered down. Examples of secondary memory include, but are not limited to, hard disk drives (HDDs) and solid-state drives (SSDs). Secondary memory relies on a memory controller to manage its memory space and process read, write, and read-modify-write requests from a host device efficiently with low latency. In some embodiments, a memory device (also called a storage device or data storage device) includes a plurality of processing cores, and is transformed to a computational storage device (CSD) by configuring two subsets of processing cores to a memory controller and a data processor, respectively. The data processor is configured to process internal computational storage operations (e.g., data processing operations) locally on the memory device, while the memory controller of the memory device specializes in performing generic storage functions including memory access functions (e.g., I/O access operations) and internal memory management functions.

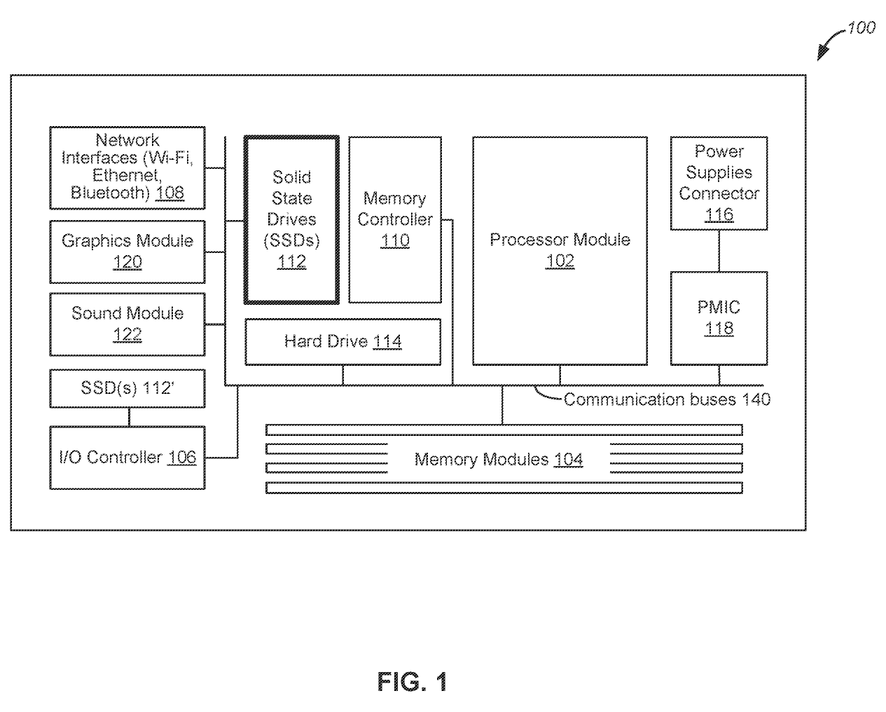

FIG. 1 is a block diagram of an example system module 100 in an electronic system in accordance with some embodiments. The system module 100 includes a processor module 102, memory modules 104 for storing programs, instructions and data, an I/O controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet, and Bluetooth networks, each allowing the electronic system to exchange data with an external source, e.g., a server or another electronic system. In some embodiments, the communication buses 140 include circuitry (sometimes called a chipset) that interconnects and controls communications among various system components included in the system module 100.

In some embodiments, the electronic system comprises a server system, a personal computer, a portable device (e.g., a smartphone, tablet, or laptop), a wearable device, a video conferencing device, and/or other type of electronic device. In some embodiments, the electronic system is, or includes, a host system. In some embodiments, the electronic system is a component of a computing system (e.g., that includes multiple electronic devices).

In some embodiments, the memory modules 104 include high-speed random-access memory, such as static random-access memory (SRAM), double data rate (DDR) dynamic random-access memory (DRAM), and/or other random-access solid state memory devices. In some embodiments, the memory modules 104 include non-volatile memory, such as one or more magnetic disk storage devices, optical disk storage devices, flash storage devices, or other non-volatile solid state storage devices. In some embodiments, the memory modules 104, or alternatively the non-volatile storage device(s) within the memory modules 104, include a non-transitory computer-readable storage medium. In some embodiments, memory slots are reserved on the system module 100 for receiving the memory modules 104. Once inserted into the memory slots, the memory modules 104 are integrated into the system module 100.

In accordance with some embodiments, the system module 100 further includes one or more of: a storage controller 110, SSD(s) 112, HDD(s) 114, a power management integrated circuit (PMIC) 118, a graphics module 120, and a sound module 122. The storage controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data storage device used for storing and retrieving digital information based on electromechanical magnetic disks. The power supply connector 116 is electrically couplable to an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively, or additionally, in some embodiments, the system module 100 further includes SSD(s) 112΄ coupled to the I/O controller 106 directly. Conversely, the SSDs 112 are coupled to the communication buses 140. In an example, the communication buses 140 operates in compliance with Peripheral Component Interconnect Express (PCIe or PCI-E), which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112΄, and HDD 114. These new non-transitory computer readable storage media include, but are not limited to, those manufactured from biological materials, nanowires, carbon nanotubes and individual molecules, even though the respective data storage technologies are currently under development and yet to be commercialized.

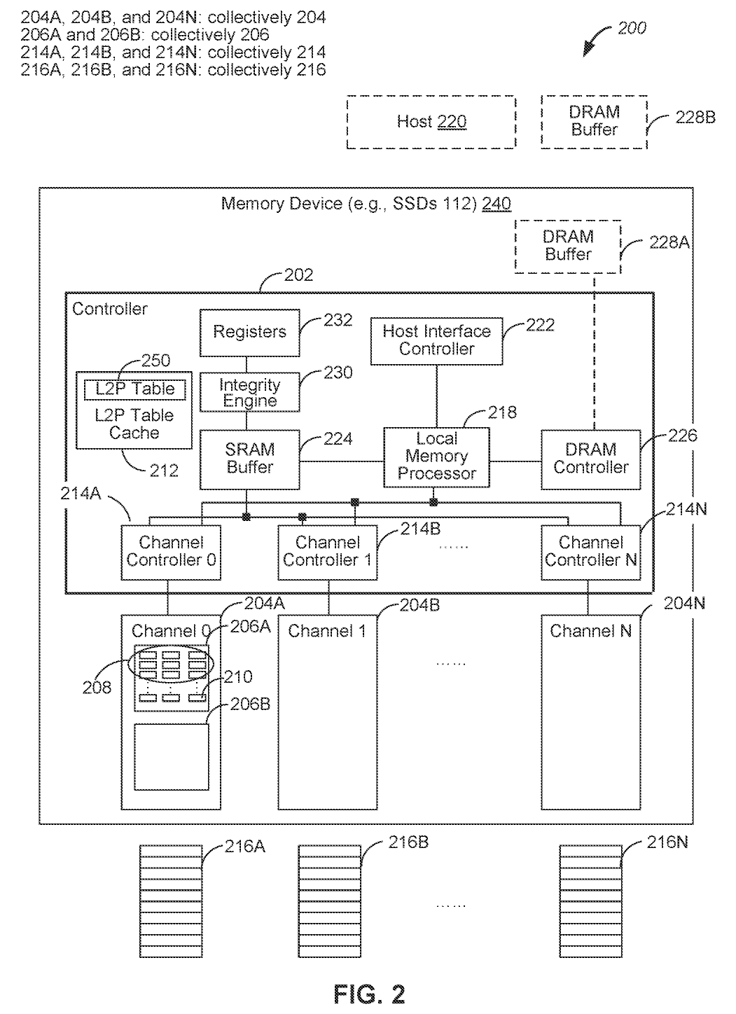

FIG. 2 is a block diagram of a storage system 200 of an example electronic device having one or more memory access queues, in accordance with some embodiments. The storage system 200 is coupled to a host device 220 (e.g., a processor module 102 in FIG. 1) and configured to store instructions and data, e.g., for an extended time, such as when the electronic device sleeps, hibernates, or is shut down. The host device 220 is configured to access the instructions and data stored in the storage system 200 and process the instructions and data, e.g., to run an operating system (OS) and execute user applications. The storage system 200 includes one or more storage devices 240 (e.g., an SSD). In the example of FIG. 2, each storage device 240 further includes a controller 202 and a plurality of memory channels 204 (e.g., channel 204A, 204B, and 204N). Each memory channel 204 includes a plurality of memory cells. The controller 202 may be configured to execute firmware-level software to bridge the plurality of memory channels 204 to the host device 220. In some embodiments, each storage device 240 is formed on a printed circuit board (PCB).

Each memory channel 204 includes on one or more memory packages 206 (e.g., two memory dies). In an example, each memory package 206 (e.g., memory package 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the storage device 240 includes a plurality of superblocks. Each superblock includes a plurality of memory blocks, each of which further includes a plurality of memory pages 210. For each superblock, the plurality of memory blocks may be configured to be written into and read from the storage system via a memory I/O interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, and each memory block is: (i) distributed on a distinct one of the plurality of memory dies 206 that includes a plurality of pages, (ii) has the same die, plane, and block designations, and (iii) is accessed via a distinct channel of the distinct memory die 206. The storage device 240 may store information of an ordered list of superblocks in a cache of the storage device 240. In some embodiments, the cache is managed by a host driver of the host device 220, and called a host managed cache (HMC).

In some embodiments, the storage device 240 includes a single-level cell (SLC) NAND flash memory chip, and each memory cell stores a single data bit. In some embodiments, the storage device 240 includes a multi-level cell (MLC) NAND flash memory chip, and each memory cell of the MLC NAND flash memory chip stores 2 or more data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits (e.g., X data bits, where X is greater than 5). Compared with the non-SLC NAND flash memory chips (e.g., MLC SSD, TLC SSD, QLC SSD, PLC SSD), the SSD that has SLC NAND flash memory chips generally operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the storage device 240 corresponds to a single queue 216 of memory access requests. Each memory access request is optionally received internally from the storage device 240 to manage the respective memory channel 204 or externally from the host device 220 to write or read data stored in the respective channel 204. Specifically, each memory access request may include one of: a system write request that is received from the storage device 240 to write to the respective memory channel 204, a system read request that is received from the storage device 240 to read from the respective memory channel 204, a host write request that originates from the host device 220 to write to the respective memory channel 204, and a host read request that is received from the host device 220 to read from the respective memory channel 204. System read requests (also called background read requests or non-host read requests) and system write requests may be dispatched by a storage controller 202 to implement internal memory management functions including, but are not limited to, garbage collection, wear levelling, read disturb mitigation, memory snapshot capturing, memory mirroring, caching, and memory sparing. In some embodiments, each of a host write request and a host read request corresponds to a respective I/O access operation. Alternatively, in some embodiments, each of a system read request, a system write request, a host write request, and a host read request corresponds to a respective I/O access operation.

In some embodiments, in addition to the channel controllers 214, the controller 202 further includes a local memory processor 218, a host interface controller 222, an SRAM buffer 224, and/or a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks is written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228A that is included in storage device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n – k) corresponds to integrity data of the user data, where k and n are positive integers. In some embodiments, the storage device 240 includes an integrity engine 230 (e.g., an LDPC engine) and registers 232, which may include a plurality of registers, SRAM cells, and/or flip-flops and are coupled to the integrity engine 230. The integrity engine 230 is coupled to the memory channels 204 via the channel controllers 214 and SRAM buffer 224. In some embodiments, the integrity engine 230 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the storage system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the controller 202. In some embodiments, the storage system 200 includes a DRAM buffer 228A, and the L2P address indirection table 250 is stored in the DRAM buffer 228A. The local memory processor 218 of the controller 202 accesses the DRAM buffer 228A via a DRAM controller 226.

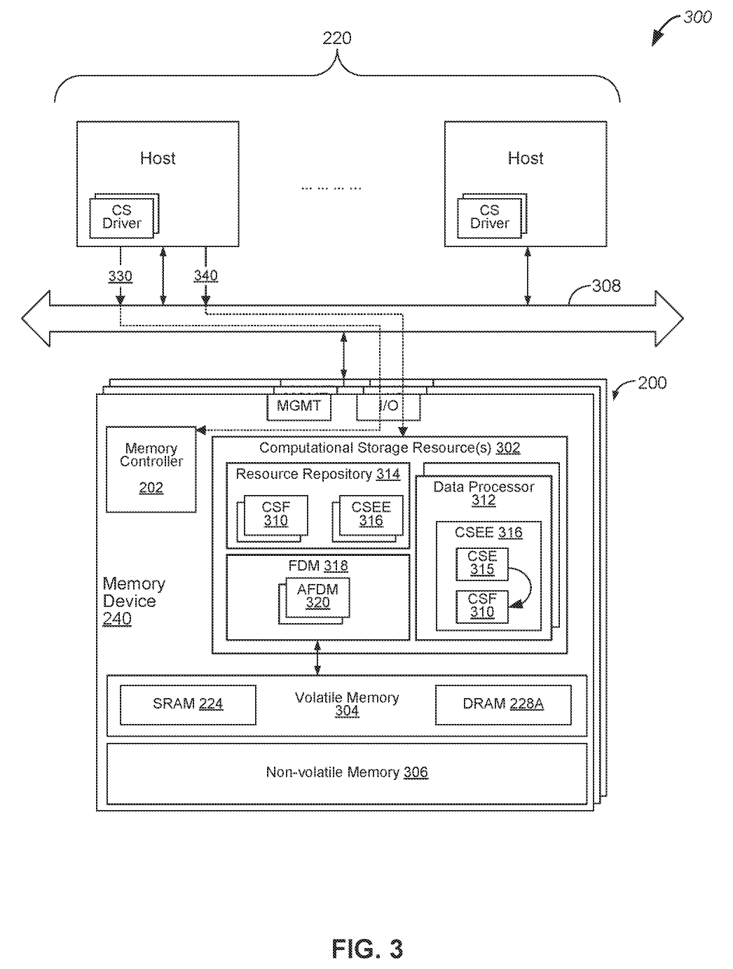

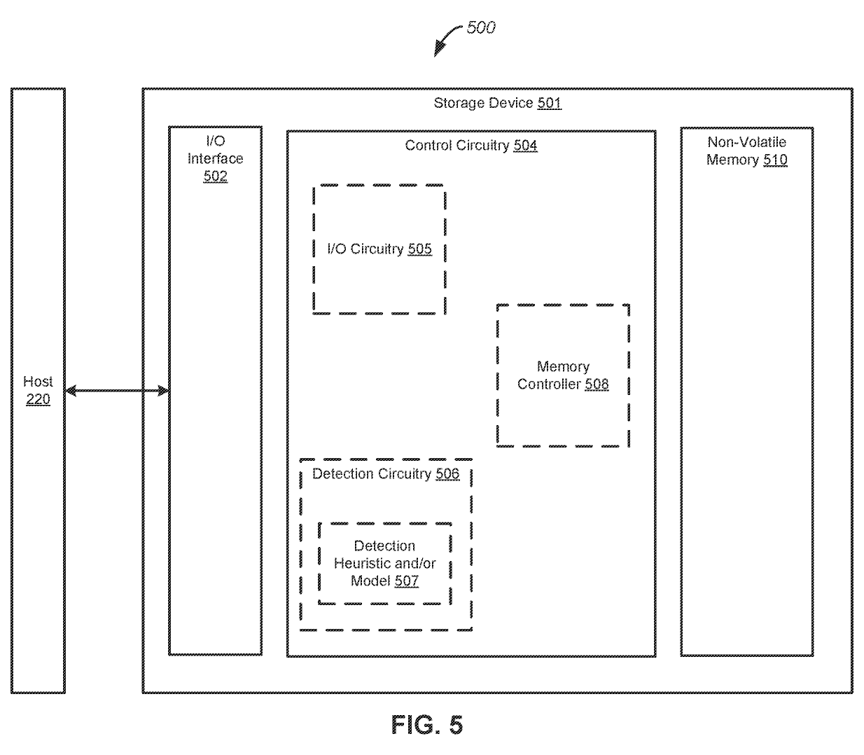

In some embodiments, a memory device 240 includes a plurality of processing cores, and is transformed to a CSD by activating a computational storage configuring two separate subsets of processing cores to a memory controller 202 and a data processor (e.g., data processor 312 in FIG. 3), respectively. The data processor is configured to process internal computational storage operations (e.g., data processing operations) locally on the memory device 240, while the memory controller 202 of the memory device 240 specializes in performing generic storage functions including memory access functions (e.g., I/O access operations) and internal memory management functions. In some embodiments, the memory controller 202 and the data processor of the memory device 240 at least partially share certain hardware resources in a time-multiplexed manner. The memory device 240 may operate in a computational storage elevation (CSE) mode, when the hardware resources (e.g., processing cores) are allocated to the computational storage functions or adjusted between the memory access functions and the computational storage functions. In some embodiments, the memory device 240 comprises one or more hardware engines (e.g., in addition to, or alternatively to, the processing cores). For example, the memory device 240 may include control circuitry such as is described below with reference to FIG. 5 (e.g., the control circuitry 504).

FIG. 3 is a block diagram of a computing system 300 that includes a storage system 200 having an internal processing capability, in accordance with some embodiments. The storage system 200 is also sometimes called a CSD, and includes one or more storage devices 240 (e.g., SSDs). Each storage device 240 further includes a storage controller 202, a volatile memory 304, and a non-volatile memory 306 (e.g., memory channels 204). The host device(s) 220 and the one or more storage devices 240 of the storage system 200 may be coupled to each other via a communication fabric 308. The communication fabric 308 includes a communication bus 140 (FIG. 1) that operates in compliance with a data bus standard, e.g., Peripheral Component Interconnect Express (PCIe), Ethernet standards. The host device(s) 220 are configured to issue memory access requests to write data into, and read data from, the non-volatile memory 306. The storage controller 202 accesses the non-volatile memory 306 in response to the memory access operations. Additionally, in some embodiments, the storage controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The volatile memory 304 of each storage device 240 further includes one or more of a L2P table cache 212, a SRAM buffer 224, and a DRAM buffer 228A, and is configured to store data temporarily while the storage controller 202 accesses the non-volatile memory 306 for memory accesses or internal memory management.

In some embodiments, the storage controller 202 is dedicated to processing the memory access requests and internal memory management functions. A storage device 240 further includes one or more computational storage resources (CSRs) 302 configured to implement data processing operations locally on the storage device 240. A set of predefined data processing operations are implemented to perform a computational storage function (CSF) 310, which is distinct from the memory access and internal memory management functions performed by the storage controller 202. In some embodiments, a computational storage resource 302 processes user data that is received from the host device(s) 220 or extracted from the non-volatile memory 306 during the data processing operations. In some embodiments, the processed data is stored into the non-volatile memory 306 or sent to the host device(s) 220 via the fabric 308. Further, in some embodiments, a subset of the user data, the process data, and/or intermediate data generated during the data processing operations is temporarily stored in the volatile memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the storage device 240. The resource repository 314 may be a centralized location (e.g., memory space) that stores various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that is used or generated by the computational storage engine 315 for performing a computational storage function 310. In some embodiments, the function data memory 318 is included in the volatile memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 220 issues a memory read or write request 330 to a storage device 240 of the storage system 200, and the storage controller 202 of the storage device 240 receives the memory read or write request 330 and accesses the non-volatile memory 306 accordingly. In some embodiments, a host device 220 issues a data processing request 340 to the storage device 240, and a data processor 312 of the computational storage resource 302 (e.g., the computational storage engine 315) receives the data processing request 340 and processes user data extracted from the data processing request or the non-volatile memory 306. In some embodiments, one or more data processors 312 are configured to access a filesystem of the host(s) 220 thereby allowing one or more computation storage resource(s) 302 to map read and write requests to (i) a particular file or filesystem metadata, (ii) navigate the hierarchy/location of files and directories, (iii) obtain metadata corresponding to the files and directories (ex. file owner), (iv) view access permissions of files and directories, and/or (v) view a list of users and groups on the filesystem. In some embodiments in which the data processor(s) 312 are configured to access the filesystem, the data processor(s) 312 are configured to determine a file type associated with a memory request and perform any of the operations described herein in accordance with the determined file type (e.g., determining whether a memory request corresponds to malicious activity).

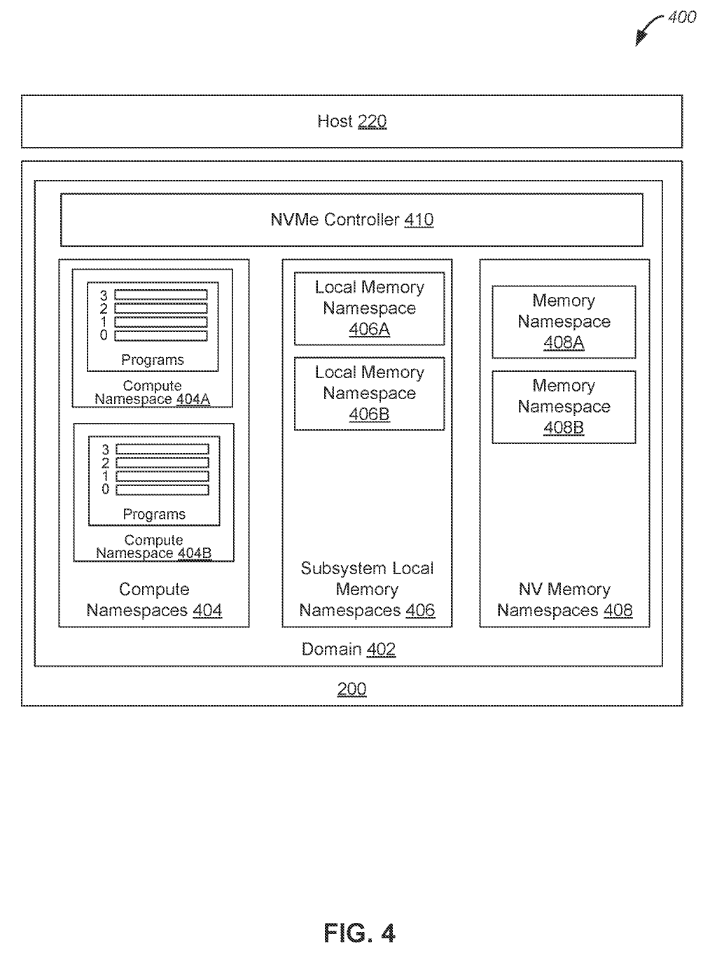

FIG. 4 is a block diagram of a computing system 400 that includes a storage system 200 that operates in compliance with a storage access and transport protocol (e.g., nonvolatile memory express (NVMe)), in accordance with some embodiments. The storage system 200 includes one or more storage devices 240 each of which corresponds to a domain 402 according to the storage access and transport protocol. Each domain 402 corresponding to a respective storage device 240 includes a one or more compute namespace 404, local memory namespaces 406, memory namespaces 408, and a domain controller 410. Each namespace is a collection of LBAs accessible to, or associated with, a respective one of the plurality of programs.

In accordance with some embodiments, a storage device 240 includes one or more processors having a computation capability (e.g., a storage controller 202, a data processor 312), a volatile memory 304 (e.g., a cache 212, a SRAM buffer 224, a DRAM buffer 228A), and a non-volatile memory 306. When the storage device 240 executes a plurality of programs, resources of the storage controller 202, the volatile memory 304, and the non-volatile memory 306 are allocated to implement the plurality of programs based on the storage access and transport protocol (e.g., NVMe). A plurality of compute namespaces 404 (e.g., 404A and 404B) correspond to, are configured to provide, instructions of the plurality of programs executed by the one or more programs of the storage device 240. Resources of the volatile memory 304 are allocated based on a plurality of local memory namespaces 406 (e.g., 406A and 406B) to facilitate execution of the plurality of programs by the storage device 240, so are resources of the non-volatile memory 306 allocated based on a plurality of memory namespaces 408 (e.g., 408A and 408B). In some embodiments, the number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the storage device 240. In some situations, input data that is processed, and output data that is generated, by these instructions is temporarily stored based on the local memory namespace 406A. In some situations, the input data is extracted based on the non-volatile memory namespace 408A, and the output data is stored based on the non-volatile memory namespace 408A. By these means, namespace allocation and utilization in the domain 402 corresponding to the storage device 240 is managed according to the storage access and transport protocol.

In some embodiments, the storage access and transport protocol includes a NVMe protocol for accessing flash storage (e.g., SSDs) via a PCI Express (PCIe) bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each storage device 240 (e.g., SSD) as a standard NVMe storage device using the NVMe protocol. The host device 220 is configured to read and write data and implement data processing operations on the storage device 240 using NVMe commands.

In some embodiments, the host device 220 uses an operating system (e.g., a Linux operating system), and the CSRs 302 (FIG. 3) of the storage device 240 use an embedded operating system (e.g., an embedded Linux operating system) that matches the operating system of the host device 220. In some embodiments, the host device 220 uses extended vendor unique commands to control and interact with the embedded operating system of the CSRs 302 of the storage device 240. In some embodiments, the host device 220 uses non-vendor commands to control and interact with the embedded operating system of the CSRs 302 of the storage device 240. In some embodiments, the CSRs 302 are implemented using programmable logic, such as an FPGA. In some embodiments, the CSRs 302 do not use an embedded OS.

FIG. 5 is a block diagram illustrating a computing system 500 (e.g., an electronic system) that includes a host 220 and a storage device 501 in accordance with some embodiments. In the example of FIG. 5, the storage device 501 includes an I/O interface 502, control circuitry 504, and non-volatile memory 510. In some embodiments, the storage device 501 includes a superset or subset of the components shown in FIG. 5.

In FIG. 5, the storage device 501 is communicatively coupled to the host 220 via the I/O interface 502 (e.g., and a communication fabric or bus). The I/O interface 502 is sometimes referred to as a host interface. The I/O interface 502 corresponds to a connection point that allows data to be transferred between the host 220 and the storage device 501. In some embodiments, the I/O interface 502 is configured to convert data received in a transport protocol to a different protocol used by components of the storage device 501. For example, the I/O interface 502 may unwrap and/or decrypt data packets received from the host 220. In some embodiments, the I/O interface 502 is configured to route data received from the host 220 to appropriate components of the storage device 501 (e.g., control circuitry 504, I/O circuitry 505, detection circuitry 506, and/or memory controller 508).

In some embodiments, the control circuitry 504 is an instance of the CSR 302 and/or the memory controller 202. The control circuitry 504 may comprise one or more processors, microprocessors, and/or other types of circuitry (e.g., FPGAs, vector processors, etc.). In some embodiments, the control circuitry 504 includes a set of instructions (e.g., in firmware and/or software). In some embodiments, the control circuitry 504 includes I/O circuitry 505, detection circuitry 506, and/or memory controller 508.

In some embodiments, the I/O circuitry 505 is configured to perform one or more sanity checks. In some embodiments, the one or more sanity checks include one or more I/O checks (e.g., checking whether a logical address for the data is valid). In some embodiments, the checks include checking an address mapping for the address. In some embodiments, the checks includes determining whether the data request complies with one or more memory access requirements. In some embodiments, the checks include a protection information (PI) check. In some embodiments, the checks include a data integrity check, such as a cyclic redundancy check (CRC). In some embodiments, the I/O circuitry 505 determines whether a data packet is valid based on the sanity check(s). For example, if the sanity check(s) each indicate that the packet is valid then the I/O circuitry 505 determines that the packet is valid, and a corresponding operation may be performed by the storage device 501. If one of the sanity check(s) indicates that the packet is invalid then the I/O circuitry 505 determines that the packet is invalid (e.g., and generates a failure notification to be sent to the host 220).

In some embodiments, the memory controller 508 is an instance of the memory controller 202 described previously. In some embodiments, the memory controller 508 governs operations performed at the non-volatile memory 510. In some embodiments, the memory controller 508 is configured to perform storage functions, including memory access functions (e.g., I/O access operations), and internal memory management functions. In some embodiments, the I/O circuitry 505 and the memory controller 508 are a single component. In some embodiments, the functionality of the memory controller 508 is incorporated in the I/O circuitry 505 and the memory controller 508 is not included in the storage device 501. In some embodiments, the non-volatile memory 510 is an instance of the non-volatile memory 306 described previously.

The detection circuitry 506 may comprise one or more processors, microprocessors, and/or other types of circuitry. In some embodiments, the detection circuitry 506 includes a set of instructions (e.g., in firmware and/or software). In some embodiments, the detection circuitry 506 comprises a dedicated processing unit. In some embodiments, the detection circuitry 506 is separate and distinct from the I/O circuitry 505. In some embodiments, the detection circuitry 506 corresponds to a first processor core and the I/O circuitry 505 corresponds to a second core of the same processor (e.g., the data processor 312). In some embodiments, the detection circuitry 506 comprises an inline processing unit (e.g., arranged along a data path between the I/O interface 502 and the I/O circuitry 505). In some embodiments, the detection circuitry 506 performs its analysis of incoming data requests before (or after) the I/O circuitry 505 processes the data requests. In some embodiments, the detection circuitry 506 performs its analysis of the incoming data requests concurrently with the I/O circuitry 505 processing the data requests. For example, the detection circuitry 506 analyses the data requests while the I/O circuitry 505 performs one or more sanity checks on the data request (e.g., prior to a memory operation corresponding to the data requests being performed). By performing the analysis concurrently with the data processing, an access latency of the storage device 501 is preserved (e.g., the analysis does not increase the latency of the storage device). In some embodiments, the detection circuitry 506 and the I/O circuitry 505 are a same component. In some embodiments, a same circuit (or set of circuits) is used to in place of the I/O circuitry 505 and the detection circuitry 506. In some embodiments, the detection circuitry 506 is configured to analyze data requests (e.g., read requests, write requests, and/or other types of I/O requests and packets) from the host 220 and identify any anomalous behavior.

In some embodiments, the detection circuitry 506 is configured to initiate one or more remedial actions in response to identifying anomalous behavior, such as generating an out-of-band notification, blocking access to the non-volatile memory 510, and/or switching to a read-only or honey-pot mode. In some embodiments, the detection circuitry 506 operates in conjunction with a CSR (e.g., the CSR 302) and/or a memory controller (e.g., the memory controller 202) to initiate the one or more remedial actions. In some embodiments, a CSR and/or memory controller is configured to initiate one or more remedial actions in response to identifying anomalous behavior. In some embodiments, the detection circuitry 506 includes one or more heuristics and/or models 507 configured to detect anomalous behavior. In some embodiments, the heuristics and/or models 507 are stored in the non-volatile memory 510. In some embodiments, the heuristics and/or models 507 are stored in a secure portion of the non-volatile memory 510. In some embodiments, the heuristics and/or models 507 are stored in a separate memory of the storage device 501. In some embodiments, the heuristics and/or models 507 include a neural network (e.g., a deep neural network or convolutional neural network), a random forest, a decision tree, a support vector machine, and/or other type of machine-learning architecture. In some embodiments, the heuristics and/or models 507 includes a first heuristics and/or model for entropy detection and a second heuristics and/or models 507 for behavior matching. In some embodiments, the heuristics and/or models 507 includes a same heuristic and/or model used for both entropy detection and behavior matching. In some embodiments, the heuristics and/or models 507 are installed at manufacturing time or loaded in production (e.g., at a customer site during an intake process) to the storage device 501, e.g., via a firmware update and/or using vendor specific commands over transport protocols such as NVMe, SMBus, PCIe, I3C, and SATA. In some embodiments, the heuristics and/or models 507 are uploaded to the storage device via a secure or integrity-protected communication channel (e.g., over any physical interface) by an administrator. In some embodiments, the detection circuitry 506 comprises a computational storage (CS) engine. For example, the heuristics and/or models 507 are used by the CS engine to perform a local inference to indicate if malicious behavior is detected based on the continuous stream of input parameters.

### Example Malicious Activity Detection/Prevention Techniques

In the following, example embodiments for identifying and preventing malicious activity are described. The techniques described below may be performed using the systems and devices described previously (e.g., the memory device 240, or the storage device 501). As described in greater detail below, a memory device (e.g., an SSD) can detect malware (e.g., ransomware) operating on data on the memory device via entropy detection, ransomware behavior matching, and/or abnormal workload detection. The memory device can protect the stored data by notifying an administrator, blocking a portion of the memory corresponding to malicious activity (e.g., blocking a particular namespace, address range, or user access), and/or switching to a read-only mode. In some embodiments, the memory device is configured to obtain (e.g., receive or generate) detection software (e.g., a heuristic and/or model) to perform the malicious activity (malware) detection. In some embodiments, the memory device is configured to train (e.g., fine tune) the detection software (e.g., using known malware and/or known workload data). In some embodiments, the detection software is provided to the memory device during manufacturing and/or provisioning. In some embodiments, the detection software is provided to the memory device via a secure connection with the host 220.

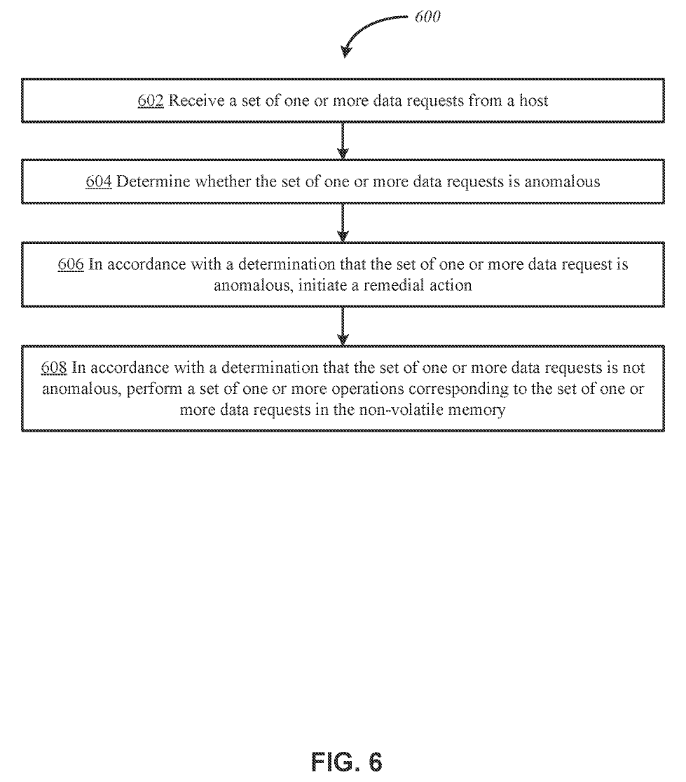

FIG. 6 is a flow diagram illustrating a method 600 for preventing malicious activity in accordance with some embodiments. The method 600 may be performed at a computing system having control circuitry and memory storing instructions for execution by the control circuitry. In some embodiments, the method 600 is performed by executing instructions stored in the memory of the computing system. In some embodiments, the method is performed at a memory device (e.g., the storage device 501) that comprises non-volatile memory and control circuitry.

(A1) The memory device receives (602) a set of one or more data requests from a host (e.g., the host 220). The memory device determines (604) whether the set of one or more data requests is anomalous (e.g., using the detection circuitry 506). In accordance with a determination that the set of one or more data request is anomalous, the memory device initiates (606) a remedial action. In accordance with a determination that the set of one or more data requests is not anomalous, the memory device performs (608) a set of one or more operations corresponding to the set of one or more data requests in memory (e.g., the non-volatile memory 510). In this way, the memory device can detect and protect from malicious activity in a self-contained manner (e.g., independent of the host device). In some embodiments, each data request corresponds to a single data operation (e.g., a write operation or read operation). In some embodiments, the set of data request(s) are received via a communication fabric or bus (e.g., the communication fabric 308). In some embodiments, the determination as to whether the set of data request(s) is anomalous is performed concurrently with one or more sanity checks for the set of data request(s). In some embodiments, the host comprises a personal computer, a server system, or other type of computing system. In some embodiments, the memory device further comprises volatile memory (e.g., the volatile memory 304). In some embodiments, the memory device determines whether the data request(s) are anomalous based on content and/or metadata of the data request(s).

(A2) In some embodiments of A1, determining whether the set of one or more data requests is anomalous comprises determining whether an entropy of the set of one or more data requests is within an entropy range. In some embodiments, the entropy range is based on past data requests from the host. In some embodiments, the entropy range is adjusted based on prior data requests. For example, an acceptable entropy range is based on activity over the past several days, weeks, or months. In some embodiments, the entropy range is based on training data associated with the host. For example, the entropy range is determined during a training session that occurs during provisioning of the memory device. In some embodiments, the entropy range corresponds to a predefined sample window (e.g., a predefined number of bits, such as 512 bits, 1024 bits, a million bits, or other amount). In some embodiments, the predefined sample window is set by a user. In some embodiments, the predefined sample window is set by an ML component (e.g., an ML model operating on the memory device). In some embodiments, the sample window comprises a rolling window (e.g., to calculate a moving entropy that changes as the data is received).

(A3) In some embodiments of A2: (i) in accordance with a determination that the entropy of the set of one or more data requests is higher than the entropy range or lower than the entropy range, initiating the remedial action; and (ii) in accordance with a determination that the entropy of the set of one or more data requests is within than the entropy range, performing the operation corresponding to the data request in the non-volatile memory (and/or in volatile memory of the memory device). For example, if the number of bits of entropy suddenly increases, it could be indicative of the data being encrypted in the host application (e.g., corresponding to a ransomware attack). As another example, if the number of bits of entropy suddenly decreases, it could be indicative of the data being deleted. In a particular example, the data stored in the memory device is unencrypted (plaintext) and an abrupt increase in entropy may be interpreted as the data being encrypted.

(A4) In some embodiments of A2 or A3, the entropy range is determined using a machine-learning (ML) model stored at the memory device. For example, the ML model is stored on the memory device during an initialization/provisioning process (e.g., prior to deployment). In some embodiments, the entropy range is determined using a heuristic stored at the memory device. The ML model may be a neural network, random forest, or other type of ML model.

(A5) In some embodiments of any of A1-A4, determining whether the set of one or more data requests is anomalous comprises one or more of: (i) determining whether the set of one or more data requests corresponds to previously-identified malicious behavior; and (ii) determining whether the set of one or more data requests corresponds to an expected workflow. In some embodiments, the previously-identified malicious behavior corresponds to known malware and/or attacks. For example, known malware is analyzed to determine corresponding attributes which can be compared to the set of data requests. In some embodiments, the expected workflow is based on one or more representative workloads (e.g., provided during provisioning of the memory device).

(A6) In some embodiments of A5, the determination as to whether the set of one or more data requests corresponds to the previously-identified malicious behavior is performed using an ML model. In some embodiments, a same ML model (e.g., a neural network) is used to analyze entropy of the set of data request(s) and determine whether the set of data request(s) corresponds to previously-identified (known) malicious behavior. For example, the ML model may be trained prior to deployment of the memory device in a production environment. In some embodiments, the ML model is uploaded to the memory device while the memory device is operating in a production environment (e.g., via a firmware update and/or using vendor-specific command(s)). In some embodiments, the ML model is uploaded to the memory device using a secure transport protocol (e.g., over NVMe, SMBus, PCIe, I3C, or SATA). In some embodiments, the ML model is uploaded to the memory device using a secure (e.g., protected) communication channel (e.g., restricted to an administrator).

(A7) In some embodiments of A5 or A6, the determination as to whether the set of one or more data requests corresponds to the expected workflow is performed using an ML model. In some embodiments, a same ML model is used to compare the set of a data request(s) to previously-identified malicious behavior and expected workflow. In some embodiments, a first ML model is used to compare the set of a data request(s) to the previously-identified malicious behavior and a second ML model is used to compare the set of a data request(s) the expected workflow. In some embodiments, the ML model is controllable (e.g., can be disabled, enabled, extracted, and/or updated) via a secure communication channel (e.g., using a secure transport protocol). In some embodiments, the memory device is configured to update the ML model (e.g., fine tune, update, or otherwise train the model). In some embodiments, the memory device performs online training based on data received during operation of the memory device (e.g., live and/or production data). In some embodiments, the memory device performs offline training (e.g., using data received during operation of the memory device and/or data received from the host or administrator). For example, in accordance with identification of new malware, the host sends training data to the memory device via a secure, authenticated connection. In some embodiments, a CS processing unit (e.g., the CSEE 316) generates and/or trains an ML model within the memory device to learn the daily workload based on access pattern, frequency, access size, address range, and the like. For example, the training may occur in a controlled environment such as a laboratory prior to production deployment.

(A8) In some embodiments of any of A1-A7, the determination as to whether the set of one or more data requests is anomalous is based on one or more of an access pattern of the set of one or more data requests, a speed of access for the set of one or more data requests, data contents of the set of one or more data requests, a time of data of the set of one or more data requests, an address range for the set of one or more data requests, a number of user accounts corresponding to the set of one or more data requests, a frequency of the set of one or more data requests, an access size for the set of one or more data requests, a namespace corresponding to the set of one or more data requests, and a transport path for the set of one or more data requests. In some embodiments, the determination as to whether the set of one or more data requests is anomalous is based on metadata associated with the set of data request(s) and/or content of the set of data request(s). In some embodiments, the determination as to whether the set of one or more data requests is anomalous is based on file movement of the set of one or more data requests, file types found in the set of one or more data requests, metadata (e.g., inodes, directories, etc.) associated with the set of data requests(s), file location (e.g., in a system directory) corresponding to the set of one or more data requests(s) and/or the file context (e.g., an application generating the data request(s)) of the set of data request(s) by accessing the host(s) 220 file system via one or more data processors 312. In some embodiments, an ML model (e.g., the heuristics and/or models 507) is trained based on one or more data request parameters, such as any of the parameters mentioned above. In some embodiments, the ML model is model trained by passing it curated training data, e.g., from any secure communication channels by an administrator over transport protocols such as NVMe, PCIe, or SMBus. In some embodiments, a CS processing unit continually analyzes the workload and/or data from a host and feeds it into the ML model. For example, if the workload differs from the model, it may indicate that malicious activity is occurring.

(A9) In some embodiments of any of A1-A8, the control circuitry comprises an access controller (e.g., the I/O circuitry 505) and a security controller (e.g., the detection circuitry 506), and the security controller determines whether the set of one or more data requests is anomalous. In some embodiments, two or more components are used to determine whether the set of data request(s) is anomalous. For example, a first component is used to analyze entropy of the set of data request(s) and a second component is used to compare the set of data request(s) with normal/abnormal operations. In some embodiments, the security controller comprises a CPU, a CPU core, an FPGA, a DSP, a microcontroller or other type of controller. In some embodiments, the security controller and the access controller are implemented in firmware and/or software of the memory device.

(A10) In some embodiments of any of A1-A8, the determination as to whether the set of one or more data requests is anomalous is performed by an inline processing engine of the control circuitry. In some embodiments, the inline processing engine is coupled between an I/O interface of the memory device and a computational storage engine (CSE) of the memory device. For example, the inline processing engine is configured to process data requests in real time as the data requests are received at the memory device. In some embodiments, the inline processing engine comprises control circuitry such as FPGAs, processors, microprocessors, vector processors, and the like. In some embodiments, the inline processing engine is implemented in hardware and/or firmware of the memory device. In some embodiments, the determination as to whether the set of one or more data requests is anomalous is performed by a CSE of the memory device.

(A11) In some embodiments of any of A1-A10, determining whether the set of one or more data requests is anomalous comprises determining whether the set of one or more data requests is indicative of a ransomware attack. In some embodiments, determining whether the set of data request(s) is anomalous comprises determining whether the set of data request(s) corresponds to a bulk copy operation, a bulk erase operation, a bulk override operation, or other type of unexpected operation within the memory device. In some embodiments, ransomware behavior is identified based on historical logs, research data, simulations, and/or runtime behavior. In some embodiments, the ransomware behavior is identified based on a profile of known ransomware. For example, an AI model is developed and/or trained within the memory device (and/or using an external data analysis tool) based on access patterns, speed of access, contents, time of day, address range, number of user accounts, and/or the types of files accessed.

(A12) In some embodiments of any of A1-A11, performing the set of one or more operations comprises performing at least one of a write operation, and a read operation. For example, the set of data request(s) may indicate memory locations to be read from the non-volatile memory and/or memory locations for data to be written into the non-volatile memory.

(A13) In some embodiments of any of A1-A12, initiating the remedial action comprises generating an out-of-band (OOB) notification indicating that the set of one or more data requests is anomalous. In some embodiments, the OOB notification is transmitted via an OOB interface (e.g., a PCIe VDM, I3C, or SMBus interface). In some embodiments, the OOB notification is transmitted outside of an operating system operating on the host. For example, the OOB notification may be transmitted to a baseboard management controller (BMC). In some embodiments, the OOB notification is transmitted to an administrator of the host (e.g., via management software). In some embodiments, OOB notifications are generated and transmitted until an administrator acknowledges and/or disables the notifications. For example, the OOB notifications may be transmitted at predefined intervals (e.g., after a predefined amount of time). In some embodiments, the host corresponds to a virtual machine and the OOB notification is transmitted to a hypervisor corresponding to the virtual machine. Providing an OOB notification to an administrator protects in the case in which the host device (e.g., an OS and/or application of the host device) is compromised.

(A14) In some embodiments of any of A1-A13, initiating the remedial action comprises forgoing performing the set of one or more operations. In some embodiments, forgoing performing the set of operation(s) comprises blocking a particular namespace, address range, and/or user corresponding to the set of data request(s). In some embodiments, the memory device blocks the particular namespace, address range, and/or user until receiving a command from an administrator. In some embodiments, forgoing performing the set of one or more operations comprises not performing certain types of operations (e.g., write operations, cryptographic operations, and the like). In some embodiments, the memory device forgoes performing data operations (e.g., read and/or write operations) until receiving a command from an administrator. In some embodiments, forgoing performing the set of operation(s) comprises transmitting an error message to the host, the error message indicating that the set of data requests was not performed. In some embodiments, forgoing performing the set of one or more operations comprises resetting a transport connection associated with the set of data request(s).

(A15) In some embodiments of any of A1-A14, initiating the remedial action comprises activating a read-only mode for the memory device. In some embodiments, activating the read-only mode comprises transmitting a notification to the host that the read-only mode is activated. In some embodiments, activating the read-only mode comprises forgoing performing any non-read operations (e.g., dropping or filtering out any non-read operations, such as write operations). In some embodiments, activating the read-only mode comprises responding to non-read data requests with corresponding error notifications. In some embodiments, the read-only mode applies to all address ranges within the memory device. In some embodiments, the read-only mode applies to a subset of all address ranges within the memory device. In some embodiments, the read-only mode remains active until receiving a command (e.g., an unlock command) from an administrator.

(A16) In some embodiments of any of A1-A14, initiating the remedial action comprises activating a honey-pot mode for the memory device. In some embodiments, while the honey-pot mode is active, the memory device indicates that all data operations are successful (e.g., forgoes providing error notifications). In some embodiments, while the honey-pot mode is active, the memory device simulates performing the set of data operation(s) (e.g., indicates that the data operations have been performed without actually performing the data operations). For example, during honey-pot mode, a read operation may return data that was not retrieved from the non-volatile memory (e.g., default or random data). In some embodiments, while the honey-pot mode is active, the memory device simulates performing some of the data operations and allows other data operations to be completed. For example, read operations may be allowed to complete while write operations are blocked and simulated. In some embodiments, while the honey-pot mode is active, data operations, data requests, and corresponding metadata (e.g., address ranges, namespaces, and the like) is logged (e.g., stored at the memory device for future review). In some embodiments, activating the honey-pot mode includes sending an alert (e.g., an OOB notification) to an administrator associated with the memory device. In some embodiments, the honey-pot mode includes generating any of the notifications described above. In some embodiments, the honey-pot mode is activated in conjunction with generating one or more notifications.

(A17) In some embodiments of any of A1-A16, the remedial action is initiated in accordance with a policy applied to the memory device. In this way, the malicious activity protection is coordinated with an administrator (e.g., via a BMC or host policy). For example, a set of policy rules stored at the memory device may indicate which remedial actions to take in response to detecting anomalous behavior. In some embodiments, the policy is received (and/or updated) from a host device. In some embodiments, the policy is received (and/or updated) from an administrator (e.g., during operation and/or provisioning of the memory device). In some embodiments, the policy is received (and/or updated) via an OOB communication. In some embodiments, the policy indicates different remedial actions to initiate based on the type of anomalous behavior. For example, if a change in entropy is detected in the data request(s) a first set of one or more remedial actions are to be performed. In this example, if the data request(s) are mapped to known malicious activity a second set of one or more remedial actions are to be performed, where the second set of remedial action(s) includes at least one action not included in the first set. In some embodiments, the type of remedial action to be initiated is based on one or more operating parameters of the memory device when the abnormal behavior is detected.

In another aspect, some embodiments include a non-transitory computer-readable storage medium storing one or more sets of instructions for execution by control circuitry of a computing system (e.g., the storage device 501), the one or more sets of instructions including instructions for performing any of the methods described herein (e.g., the method 600 and A1-A17 above).

Each of the above identified elements may be stored in one or more of the previously mentioned storage devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A method of preventing malicious activity, the method comprising:
at a memory device that comprises non-volatile memory and control circuitry:
receiving a set of one or more data requests from a host;
determining whether the set of one or more data requests is anomalous;
in accordance with a determination that the set of one or more data request is anomalous, initiating a remedial action; and
in accordance with a determination that the set of one or more data requests is not anomalous, performing a set of one or more operations corresponding to the set of one or more data requests in the non-volatile memory.

2. The method of claim 1, wherein determining whether the set of one or more data requests is anomalous comprises determining whether an entropy of the set of one or more data requests is within an entropy range.

3. The method of claim 2, wherein:
in accordance with a determination that the entropy of the set of one or more data requests is higher than the entropy range or lower than the entropy range, initiating the remedial action; and
in accordance with a determination that the entropy of the set of one or more data requests is within than the entropy range, performing the set of one or more operations in the non-volatile memory.

4. The method of claim 2, wherein the entropy range is determined using a machine-learning (ML) model stored at the memory device.

5. The method of claim 1, wherein determining whether the set of one or more data requests is anomalous comprises one or more of:
determining whether the set of one or more data requests corresponds to previously-identified malicious behavior; and
determining whether the set of one or more data requests corresponds to an expected workflow.

6. The method of claim 5, wherein the determination as to whether the set of one or more data requests corresponds to the previously-identified malicious behavior is performed using an ML model.

7. The method of claim 5, wherein the determination as to whether the set of one or more data requests corresponds to the expected workflow is performed using an ML model.

8. The method of claim 1, wherein the determination as to whether the set of one or more data requests is anomalous is based on one or more of:
an access pattern of the set of one or more data requests,
a speed of access for the set of one or more data requests,
data contents of the set of one or more data requests,
a time of data of the set of one or more data requests,
an address range for the set of one or more data requests,
a number of user accounts corresponding to the set of one or more data requests,
a type of file corresponding to the set of one or more data requests,
a frequency of the set of one or more data requests,
an access size for the set of one or more data requests,
a namespace corresponding to the set of one or more data requests, and
a transport path for the set of one or more data requests.

9. The method of claim 1, wherein the control circuitry comprises an access controller and a security controller, and wherein the security controller determines whether the set of one or more data requests is anomalous.

10. The method of claim 1, wherein the determination as to whether the set of one or more data requests is anomalous is performed by an inline processing engine of the control circuitry.

11. The method of claim 1, wherein determining whether the set of one or more data requests is anomalous comprises determining whether the set of one or more data requests is indicative of a ransomware attack.

12. The method of claim 1, wherein performing the set of one or more operations comprises performing at least one of a write operation, and a read operation.

13. The method of claim 1, wherein initiating the remedial action comprises generating an out-of-band (OOB) notification indicating that the set of one or more data requests is anomalous.

14. The method of claim 1, wherein initiating the remedial action comprises forgoing performing the set of one or more operations.

15. The method of claim 1, wherein initiating the remedial action comprises activating a read-only mode for the memory device.

16. The method of claim 1, wherein initiating the remedial action comprises activating a honey-pot mode for the memory device.

17. A memory device, comprising:
non-volatile memory; and
control circuitry configured to:
receive a set of one or more data requests from a host;
determine whether the set of one or more data requests is anomalous;
in accordance with a determination that the set of one or more data request is anomalous, initiate a remedial action; and
in accordance with a determination that the set of one or more data requests is not anomalous, perform a set of one or more operations corresponding to the set of one or more data requests in the non-volatile memory.

18. The memory device of claim 17, wherein determining whether the set of one or more data requests is anomalous comprises one or more of:
determining whether an entropy of the set of one or more data requests is within an entropy range;
determining whether the set of one or more data requests corresponds to previously-identified malicious behavior; and
determining whether the set of one or more data requests corresponds to an expected workflow.

19. A non-transitory computer-readable storage medium storing instructions, which when executed by a memory device, cause the memory device to:
receive a set of one or more data requests from a host;
determine whether the set of one or more data requests is anomalous;
in accordance with a determination that the set of one or more data request is anomalous, initiate a remedial action; and
in accordance with a determination that the set of one or more data requests is not anomalous, perform a set of one or more operations corresponding to the set of one or more data requests in non-volatile memory of the memory device.

20. The non-transitory computer-readable storage medium of claim 19, wherein determining whether the set of one or more data requests is anomalous comprises one or more of:
determining whether an entropy of the set of one or more data requests is within an entropy range;
determining whether the set of one or more data requests corresponds to previously-identified malicious behavior; and
determining whether the set of one or more data requests corresponds to an expected workflow.
